(19) United States
(12) Patent Application Publication
(10) Pub. No.: US 2024/0047118 A1
(43) Pub. Date: Feb. 8, 2024

(54) TRANSFORMER

(71) Applicant: Delta Electronics, Inc., Taoyuan City (TW)

(72) Inventors: Po-Sheng Wang, Taoyuan City (TW); Hsi-Kuo Chung, Taoyuan City (TW); Chih-Ming Chen, Taoyuan City (TW); Hsiang-Yi Tseng, Taoyuan City (TW); Hsi-Chen Liu, Taoyuan City (TW)

(21) Appl. No.: 17/989,609

(22) Filed: Nov. 17, 2022

(30) Foreign Application Priority Data
Aug. 4, 2022 (CN) 202210931533.6

(51) Int. Cl. H01F 27/02; H01F 27/26; H01F 27/30; H01F 27/28; H01F 27/32

(52) U.S. Cl. CPC H01F 27/027; H01F 27/263; H01F 27/306; H01F 27/2823; H01F 27/325

(57) ABSTRACT

A transformer includes a magnetic core assembly, a bobbin, two first windings, a second winding and at least one circuit board. The bobbin includes a bobbin main body, a bobbin channel and a winding portion. The winding portion is formed on an outer periphery surface of the bobbin main body. The two first windings are disposed around the winding portion. One of the two first windings is disposed between the other one of the two first windings and the outer periphery surface of the bobbin main body. The second winding is disposed around the winding portion and disposed between the two first windings. The at least one circuit board includes a circuit board hole. The circuit board hole and the bobbin channel are communicated with each other. The magnetic core assembly partially penetrates through the circuit board hole and the bobbin channel.

### CROSS-REFERENCE TO RELATED APPLICATION

This application claims priority to China Patent Application No. 202210931533.6 filed on Aug. 4, 2022, the entire contents of which are incorporated herein by reference for all purposes.

### FIELD OF THE INVENTION

The present invention relates to a transformer, and more particularly to a transformer utilizing a circuit board to form a coil.

### BACKGROUND OF THE INVENTION

In the field of industrial power, the power consumption of the motor is more than 65% of all industrial power. The motor having an inverter can reduce more than 40% of the power consumption and reduce the emission of carbon dioxide. In addition, the motor regulates its speed through the inverter so as to reduce the power consumption, reduce the impact of the starting current on the power grid, reduce the wear and tear of the motor and other mechanical equipment and decrease the maintenance cost. Consequently, the improved performance of the inverter can increase the overall performance of the motor.

The transformer disposed in the inverter usually has a multi-winding design due to different functions. Each winding in the multi-winding of the conventional transformer is disposed around the magnetic core in an irregular arrangement, which results in that the actual application voltage of the transformer is drifted easily. The manufacturing process of the conventional transformer is complex and cannot be automated. Consequently, the conventional transformer has the disadvantages of high labor cost, low performance of industrial automation, unstable product characteristics and dimensions.

Therefore, there is a need of providing a transformer to obviate the drawbacks encountered from the prior arts.

### SUMMARY OF THE INVENTION

The present disclosure provides a transformer. One of the two first windings of the transformer of the present disclosure is disposed between the other one of the two first windings and the outer periphery surface of the bobbin main body. The second winding of the transformer of the present disclosure is disposed between the two first windings. Namely, one of the two first windings, the second winding and the other one of the two first windings are stacked with each other in sequence. The leakage inductance of the transformer of the present disclosure is reduced substantially due to the arrangement of the two first windings and the second winding of the transformer of the present disclosure as mentioned above. The arrangement of the two first windings and the second winding of the transformer of the present disclosure is sequential and not easy to be interlaced and wound with each other. Consequently, the transformer of the present disclosure has the advantages of simple process and thus achieving automation easily, stable product quality and dimension, great product commonality and small volume.

In accordance with an aspect of the present disclosure, there is provided a transformer. The transformer includes a magnetic core assembly, a bobbin, two first windings, a second winding and at least one circuit board. The magnetic core assembly includes a first magnetic core and a second magnetic core. The bobbin includes a bobbin main body, a bobbin channel and a winding portion. The bobbin channel runs through two opposite sides of the bobbin main body. The winding portion is formed on an outer periphery surface of the bobbin main body. The two first windings are disposed around the winding portion. One of the two first windings is disposed between the other one of the two first windings and the outer periphery surface of the bobbin main body. The second winding is disposed around the winding portion and disposed between the two first windings. The at least one circuit board includes a circuit board hole. The circuit board hole and the bobbin channel are communicated with each other. The magnetic core assembly partially penetrates through the circuit board hole and the bobbin channel.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a transformer according to a first embodiment of the present disclosure;

FIG. 2 is a schematic exploded view illustrating the transformer of FIG. 1; and

FIG. 3 is a partial schematic cross-sectional view illustrating the transformer of FIG. 1 taken along the line A-A′.

### DETAILED DESCRIPTION OF THE PREFERRED EMBODIMENT

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

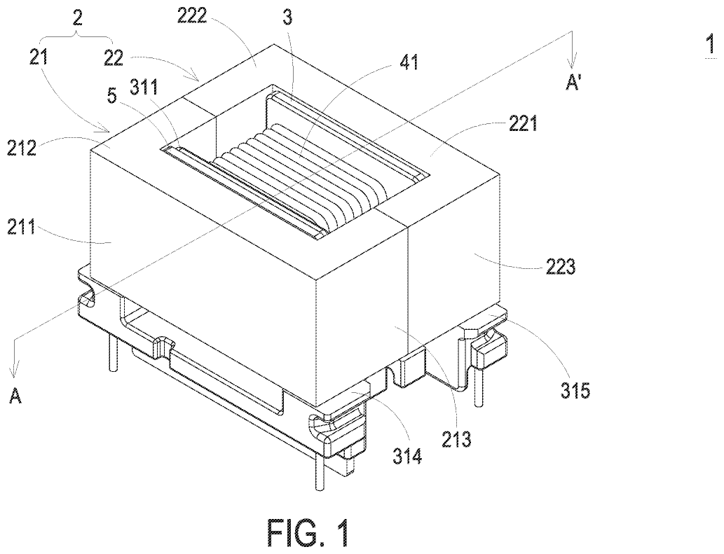

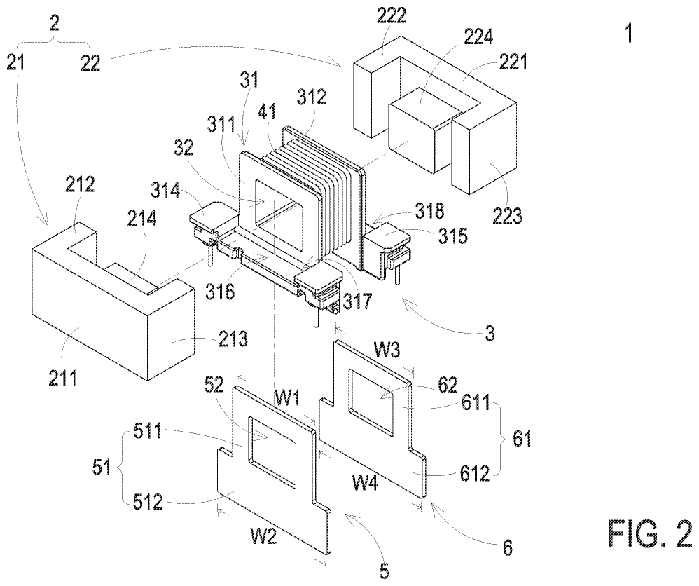

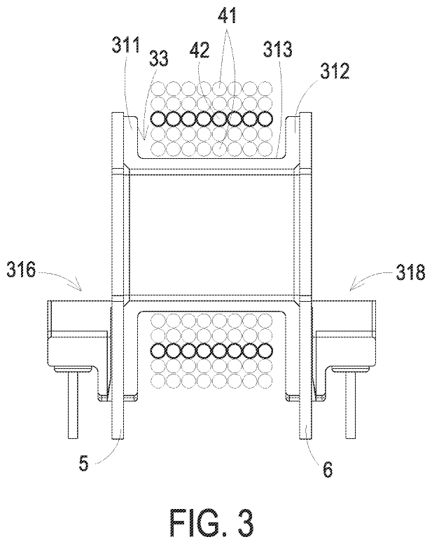

FIG. 1 is a schematic view illustrating a transformer according to a first embodiment of the present disclosure. FIG. 2 is a schematic exploded view illustrating the transformer of FIG. 1. FIG. 3 is a partial schematic cross-sectional view illustrating the transformer of FIG. 1 taken along the line A-A′. As shown in FIGS. 1 to 3, the transformer 1 includes a magnetic core assembly 2, a bobbin 3, two first windings 41, a second winding 42, a first circuit board 5 and a second circuit board 6.

The magnetic core assembly 2 includes a first magnetic core 21 and a second magnetic core 22. In this embodiment, as shown in FIG. 2, the first magnetic core 21 includes a first cover part 211, a first lateral core part 212, a second lateral core part 213 and a first middle core part 214. The first lateral core part 212 and the second lateral core part 213 are respectively connected with two opposite sides of the first cover part 211 and located in two opposite sides of the transformer 1. The first middle core part 214 is connected with the first cover part 211 and disposed between the first lateral core part 212 and the second lateral core part 213. The second magnetic core 22 includes a second cover part 221, a third lateral core part 222, a fourth lateral core part 223 and a second middle core part 224. The second cover part 221 and the first cover part 211 are located in two opposite sides of the transformer 1. The third lateral core part 222 and the fourth lateral core part 223 are connected with two opposite sides of the second cover part 221 and located in two opposite sides of the transformer 1. The third lateral core part 222 and the first lateral core part 212 are spatially corresponding in position to each other and disposed between the second cover part 221 and the first cover part 211. The fourth lateral core part 223 and the second lateral core part 213 are spatially corresponding in position to each other and disposed between the second cover part 221 and the first cover part 211. The second middle core part 224 is connected with the second cover part 221 and disposed between the third lateral core part 222 and the fourth lateral core part 223. The second middle core part 224 and the first middle core part 214 are spatially corresponding in position to each other and disposed between the second cover part 221 and the first cover part 211.

The bobbin 3 includes a bobbin main body 31, a bobbin channel 32 and at least one winding portion 33. For simplifying the figure, the structure of the magnetic core assembly 2 is not shown in FIG. 3. As shown in FIGS. 2 and 3, the bobbin main body 31 includes a first lateral wall 311, a second lateral wall 312 and an outer periphery surface 313. The first lateral wall 311 and the second lateral wall 312 of the bobbin main body 31 are located in two opposite sides of the bobbin main body 31. The first lateral wall 311 is located between the first cover part 211 of the first magnetic core 21 and the second lateral wall 312. The second lateral wall 312 is located between the second cover part 221 of the second magnetic core 22 and the first lateral wall 311. The outer periphery surface 313 of the bobbin main body 31 is located between the first lateral wall 311 and the second lateral wall 312. As shown in FIGS. 2 and 3, the first lateral wall 311 of the bobbin main body 31 is protruded out of the outer periphery surface 313, and the second lateral wall 312 of the bobbin main body 31 is protruded out of the outer periphery surface 313. In this embodiment, the number of the winding portion 33 of the bobbin 3 is one. The winding portion 33 is defined by the first lateral wall 311 protruded out of the outer periphery surface 313, the second lateral wall 312 protruded out of the outer periphery surface 313 and the outer periphery surface 313 collaboratively so as to form the winding portion 33 on the outer periphery surface 313 of the bobbin main body 31. The bobbin main body 31 is a hollow structure so as to form the bobbin channel 32. The bobbin channel 32 runs through the first lateral wall 311 and the second lateral wall 312 of the bobbin main body 31.

The two first windings 41 form a first primary coil of the transformer 1 collaboratively. The two first windings 41 are disposed around the winding portion 33. One of the two first windings 41 is disposed around the winding portion 33 and disposed between the other one of the two first windings 41 and the outer periphery surface 313 of the bobbin main body 31. The second winding 42 forms a first secondary coil of the transformer 1. The second winding 42 is disposed around one of the two first windings 41 and disposed around the winding portion 33. The second winding 42 is disposed between one of the two first windings 41 and the other one of the two first windings 41, that is, disposed between the two first windings 41. Namely, one of the two first windings 41, the second winding 42 and the other one of the two first windings 41 are stacked with each other in sequence.

The wiring of the first circuit board 5 forms a second primary coil of the transformer 1. As shown in FIG. 1, the first circuit board 5 is disposed between the first cover part 211 of the first magnetic core 21 and the first lateral wall 311 of the bobbin main body 31. The first circuit board 5 is further disposed between the first cover part 211 of the first magnetic core 21 and the second circuit board 6. The first circuit board 5 includes a first circuit board main body 51 and a first circuit board hole 52. The first circuit board hole 52 runs through the first circuit board main body 51. The first circuit board hole 52 and the bobbin channel 32 are spatially corresponding in position to each other. The wiring of the second circuit board 6 forms a second secondary coil of the transformer 1. As shown in FIGS. 1 and 2, the second circuit board 6 is disposed between the second cover part 221 of the second magnetic core 22 and the second lateral wall 312 of the bobbin main body 31. The second circuit board 6 is further disposed between the second cover part 221 of the second magnetic core 22 and the first circuit board 5. The second circuit board 6 includes a second circuit board main body 61 and a second circuit board hole 62. The second circuit board hole 62 runs through the second circuit board main body 61. The second circuit board hole 62 and the bobbin channel 32 are spatially corresponding in position to each other. The first circuit board hole 52, the second circuit board hole 62 and the bobbin channel 32 are communicated with each other. The first middle core part 214 of the first magnetic core 21 of the magnetic core assembly 2 penetrates through the first circuit board hole 52 and the bobbin channel 32. The second middle core part 224 of the second magnetic core 22 of the magnetic core assembly 2 penetrates through the second circuit board hole 62 and the bobbin channel 32. The first middle core part 214 of the first magnetic core 21 and the second middle core part 224 of the second magnetic core 22 are connected with each other within the bobbin channel 32, so that the two first windings 41 and the second winding 42 are disposed around the first middle core part 214 of the first magnetic core 21 and the second middle core part 224 of the second magnetic core 22. The first lateral core part 212 of the first magnetic core 21 and the third lateral core part 222 of the second magnetic core 22 are connected with each other. The second lateral core part 213 of the first magnetic core 21 and the fourth lateral core part 223 of the second magnetic core 22 are connected with each other. Consequently, the transformer 1 has been assembled completely as shown in FIG. 1.

From the above, one of the two first windings 41 of the transformer 1 of the present disclosure is disposed between the other one of the two first windings 41 and the outer periphery surface 313 of the bobbin main body 31. The second winding 42 of the transformer 1 of the present disclosure is disposed between the two first windings 41. Namely, one of the two first windings 41, the second winding 42 and the other one of the two first windings 41 are stacked with each other in sequence. While in the conventional transformer, each winding is disposed around the magnetic core in an irregular arrangement. Compared with the conventional transformer, the leakage inductance of the transformer 1 of the present disclosure is reduced substantially due to the arrangement of the two first windings 41 and the second winding 42 of the transformer 1 of the present disclosure as mentioned above. The arrangement of the two first windings 41 and the second winding 42 of the transformer 1 of the present disclosure is sequential and not easy to be interlaced and wound with each other. Consequently, the transformer 1 of the present disclosure has the advantages of simple process and thus achieving automation easily, stable product quality and dimension, great product commonality and small volume.

Please refer to FIGS. 1 and 2. The bobbin main body 31 further includes a first receiving portion 314 and a second receiving portion 315. The first receiving portion 314 and the second receiving portion 315 are disposed in two opposite sides of the bobbin main body 31. The first receiving portion 314 is connected with one side of the first lateral wall 311 of the bobbin main body 31. The first receiving portion 314 and the bobbin channel 32 are staggered with each other, so that the first receiving portion 314 is not covered on the bobbin channel 32. When the transformer 1 has been assembled completely, the first middle core part 214 of the first magnetic core 21 of the magnetic core assembly 2 penetrates through the first circuit board hole 52 and the bobbin channel 32, and the second middle core part 224 of the second magnetic core 22 of the magnetic core assembly 2 penetrates through the second circuit board hole 62 and the bobbin channel 32, so that the first middle core part 214 of the first magnetic core 21 and the second middle core part 224 of the second magnetic core 22 are connected with each other within the bobbin channel 32. Meanwhile, as shown in FIG. 1, the first receiving portion 314 is adjacent to the first cover part 211 of the first magnetic core 21, the edge of the first receiving portion 314 and the first cover part 211 are located at the same plane, and the plane is parallel to the first lateral wall 311 of the bobbin main body 31. In this embodiment, the first receiving portion 314 further includes a first concave 316. The first concave 316 is concavely formed on the top surface of the first receiving portion 314. The first concave 316 includes a first slot 317. The second receiving portion 315 is connected with one side of the second lateral wall 312 of the bobbin main body 31. The second receiving portion 315 and the bobbin channel 32 are staggered with each other, so that the second receiving portion 315 is not covered on the bobbin channel 32. When the transformer 1 has been assembled completely, the first middle core part 214 of the first magnetic core 21 of the magnetic core assembly 2 penetrates through the first circuit board hole 52 and the bobbin channel 32, and the second middle core part 224 of the second magnetic core 22 of the magnetic core assembly 2 penetrates through the second circuit board hole 62 and the bobbin channel 32, so that the first middle core part 214 of the first magnetic core 21 and the second middle core part 224 of the second magnetic core 22 are connected with each other within the bobbin channel 32. Meanwhile, as shown in FIG. 1, the second receiving portion 315 is adjacent to the second cover part 221 of the second magnetic core 22, and the edge of the second receiving portion 315 and the second cover part 221 are located at the same plane, and the plane is parallel to the second lateral wall 312 of the bobbin main body 31. In this embodiment, the second receiving portion 315 further includes a second concave 318. The second concave 318 is concavely formed on the top surface of the second receiving portion 315. The second concave 318 includes a second slot. The second slot is not shown in FIG. 2, but it is clear that the second slot is spatially corresponding in position to the first slot 317.

Please refer to FIG. 2. In this embodiment, the first circuit board main body 51 includes a first sub main body 511 and a second sub main body 512. The first sub main body 511 and the second sub main body 512 are integrally formed into one piece. The width W1 of the first sub main body 511 is less than the width W2 of the second sub main body 512. The first circuit board hole 52 is located at the first sub main body 511. The first circuit board main body 51 is inserted into the first slot 317 through the bottom surface of the first receiving portion 314, so that at least portion of the first sub main body 511 is disposed in the first concave 316, and at least portion of the second sub main body 512 is disposed on the bottom surface of the first receiving portion 314. The first sub main body 511 of the first circuit board main body 51 is disposed between the first lateral wall 311 of the bobbin main body 31 and the first cover part 211 of the first magnetic core 21. The first circuit board hole 52 is communicated with the bobbin channel 32, so that the first middle core part 214 of the first magnetic core 21 penetrates through the first circuit board hole 52 and the bobbin channel 32 in sequence. The second circuit board main body 61 includes a third sub main body 611 and a fourth sub main body 612. The third sub main body 611 and the fourth sub main body 612 are integrally formed into one piece. The width W3 of the third sub main body 611 is less than the width W4 of the fourth sub main body 612. The second circuit board hole 62 is located at the third sub main body 611. The second circuit board main body 61 is inserted into the second slot through the bottom surface of the second receiving portion 315, so that at least portion of the third sub main body 611 is disposed in the second concave 318, and at least portion of the fourth sub main body 612 is disposed on the bottom surface of the second receiving portion 315. The third sub main body 611 of the second circuit board main body 61 is disposed between the second lateral wall 312 of the bobbin main body 31 and the second cover part 221 of the second magnetic core 22. The second circuit board hole 62 is communicated with the bobbin channel 32, so that the second middle core part 224 of the second magnetic core 22 penetrates through the second circuit board hole 62 and the bobbin channel 32 in sequence. In some embodiments, the width W2 of the second sub main body 512 is less than or equal to the width W1 of the first sub main body 511, so that the first circuit board main body 51 is inserted into the first slot 317 through the top surface of the first receiving portion 314. The width W4 of the fourth sub main body 612 is less than or equal to the width W3 of the third sub main body 611, so that the second circuit board main body 61 is inserted into the second slot through the top surface of the second receiving portion 315.

Certainly, in some embodiments, it is not necessary to install the first receiving portion and the second receiving portion on the transformer. The transformer of an embodiment utilizes the first middle core part of the first magnetic core to penetrate through the first circuit board hole and the bobbin channel so as to dispose the first circuit board between the first cover part of the first magnetic core and the bobbin main body. Similarly, the transformer of an embodiment utilizes the second middle core part of the second magnetic core to penetrate through the second circuit board hole and the bobbin channel so as to dispose the second circuit board between the second cover part of the second magnetic core and the bobbin main body.

As mentioned above, one of the two first windings of the transformer of the present disclosure is disposed between the other one of the two first windings and the outer periphery surface of the bobbin main body. The second winding of the transformer of the present disclosure is disposed between the two first windings. Namely, one of the two first windings, the second winding and the other one of the two first windings are stacked with each other in sequence. Compared with the conventional transformer having each winding disposed around the magnetic core in an irregular arrangement, the leakage inductance of the transformer of the present disclosure is reduced substantially due to the arrangement of the two first windings and the second winding of the transformer of the present disclosure as mentioned above. The arrangement of the two first windings and the second winding of the transformer of the present disclosure is sequential and not easy to be interlaced and wound with each other. Consequently, the transformer of the present disclosure has the advantages of simple process and thus achieving automation easily, stable product quality and dimension, great product commonality and small volume.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A transformer, comprising:
a magnetic core assembly comprising a first magnetic core and a second magnetic core;
a bobbin comprising a bobbin main body, a bobbin channel and a winding portion, wherein the bobbin channel runs through two opposite sides of the bobbin main body, and the winding portion is formed on an outer periphery surface of the bobbin main body;
two first windings disposed around the winding portion, wherein one of the two first windings is disposed between the other one of the two first windings and the outer periphery surface of the bobbin main body;
a second winding disposed around the winding portion and disposed between the two first windings; and
at least one circuit board comprising a circuit board hole, wherein the circuit board hole and the bobbin channel are communicated with each other, and the magnetic core assembly partially penetrates through the circuit board hole and the bobbin channel.

2. The transformer according to claim 1, wherein the at least one circuit board comprises a first circuit board and a second circuit board, the first circuit board is disposed between the first magnetic core and the bobbin main body and comprises a first circuit board hole, the second circuit board is disposed between the second magnetic core and the bobbin main body and comprises a second circuit board hole, the first circuit board hole, the second circuit board hole and the bobbin channel are communicated with each other, and the magnetic core assembly partially penetrates through the first circuit board hole, the second circuit board hole and the bobbin channel.

3. The transformer according to claim 2, wherein the first magnetic core comprises a first cover part, a first lateral core part, a second lateral core part and a first middle core part, the first lateral core part and the second lateral core part are connected with two opposite sides of the first cover part, and the first middle core part is connected with the first cover part and disposed between the first lateral core part and the second lateral core part, wherein the second magnetic core comprises a second cover part, a third lateral core part, a fourth lateral core part and a second middle core part, the second cover part is spatially corresponding in position to the first cover part, the third lateral core part and the fourth lateral core part are connected with two opposite sides of the second cover part, the third lateral core part is connected with the first lateral core part, the fourth lateral core part is connected with the second lateral core part, the second middle core part is connected with the second cover part and disposed between the third lateral core part and the fourth lateral core part, and the second middle core part is connected with the first middle core part, wherein the first middle core part and the second middle core part penetrates through the first circuit board hole, the second circuit board hole and the bobbin channel.

4. The transformer according to claim 2, wherein the bobbin main body comprises a first lateral wall, a second lateral wall, a first receiving portion and a second receiving portion, the first lateral wall and the second lateral wall are located in two opposite sides of the bobbin main body, the outer periphery surface of the bobbin main body is located between the first lateral wall and the second lateral wall, and the bobbin channel runs through the first lateral wall and the second lateral wall of the bobbin main body, wherein the first receiving portion is connected with one side of the first lateral wall of the bobbin main body, the first receiving portion and the bobbin channel are staggered with each other, so that the first receiving portion is not covered on the bobbin channel, and the first receiving portion comprises a first concave having a first slot, wherein the second receiving portion is connected with one side of the second lateral wall of the bobbin main body, the second receiving portion and the bobbin channel are staggered with each other, so that the second receiving portion is not covered on the bobbin channel, and the second receiving portion comprises a second concave having a second slot.

5. The transformer according to claim 4, wherein the first circuit board comprises a first circuit board main body, the first circuit board hole runs through the first circuit board main body, at least portion of the first circuit board main body is inserted into the first slot, and the first circuit board is disposed between the bobbin main body and a first cover part of the first magnetic core, wherein the second circuit board comprises a second circuit board main body, the second circuit board hole runs through the second circuit board main body, at least portion of the second circuit board main body is inserted into the second slot, and the second circuit board is disposed between the bobbin main body and a second cover part of the second magnetic core.

6. The transformer according to claim 2, wherein the two first windings form a first primary coil of the transformer collaboratively, the second winding forms a first secondary coil of the transformer, the first circuit board forms a second primary coil of the transformer, and the second circuit board forms a second secondary coil of the transformer.
